(19) United States
(12) Patent Application Publication
(10) Pub. No.: US 2026/0093310 A1
(43) Pub. Date: Apr. 2, 2026

(54) COMPENSATING FOR ON-CHIP POWER SUPPLY VOLTAGE TRANSIENTS

(71) Applicant: Apple Inc., Cupertino, CA (US)

(72) Inventors: Jared L. ZERBE, Woodside, CA (US); Eric G. SMITH, San Jose, CA (US); Joao Pedro da Silva CERQUEIRA, Santa Clara, CA (US); Davia V. MCKENZIE, Baltimore, MD (US)

(21) Appl. No.: 18/979,217

(22) Filed: Dec. 12, 2024

Related U.S. Application Data
(60) Provisional application No. 63/700,453, filed on Sep. 27, 2024.

(51) Int. Cl. G06F 1/324; G06F 1/08; G06F 1/3206; G06F 1/3296

(52) U.S. Cl. CPC G06F 1/324; G06F 1/08; G06F 1/3206; G06F 1/3296

(57) ABSTRACT

A method for detecting and compensating for power supply voltage droop in a computer system is disclosed. The computer system includes a clock generator circuit that generates a global clock signal, which is distributed by a forward clock network to generate multiple distributed clock signals. A backward clock network may select one or more of the multiple distributed clock signals for back propagation to the clock generator circuit. A control circuit may perform a phase comparison between the global clock signal and the one or more of the multiple distributed clock signals. The clock generator circuit may modify the global clock signal using a result of the phase comparison.

### CROSS-REFERENCE TO RELATED APPLICATIONS

The present application claims the benefit of U.S. Provisional Application No. 63/700,453, entitled “COMPENSATING FOR ON-CHIP POWER SUPPLY VOLTAGE TRANSIENTS,” filed Sep. 27, 2024, the content of which is incorporated by reference herein in its entirety for all purposes.

### FIELD

This disclosure relates to power management in computer systems and, more particularly, to the detection of and compensation for power supply voltage transients.

### BACKGROUND

Modern computer systems include multiple circuit blocks designed to perform various functions. For example, such circuit blocks may include processors or processor cores configured to execute software or program instructions. Additionally, the circuit blocks may include memory circuits, mixed-signal or analog circuits, and the like.

In some computer systems, the circuit blocks may be designed to operate using different power supply voltage levels. For example, in some computer systems, power circuits (also referred to as “power management units”) may generate and monitor various power supply signals. Such power circuits may be located on a common integrated circuit with a processor circuit, memory circuit, and the like. Alternatively, power circuits may be located on different integrated circuits from the processor circuit, memory circuit, etc.

Power circuits often include one or more power converter circuits that can generate regulated voltage levels on respective power supply signal nodes, which are connected to load circuit blocks via power supply networks. Such power converter circuits may employ multiple reactive circuit elements such as inductors, capacitors, and the like, while such power supply networks may include parasitic resistances, inductances, and capacitances.

### BRIEF DESCRIPTION OF THE DRAWINGS

FIG. 1 is a block diagram depicting an embodiment of a computer system.

FIG. 2 is a block diagram depicting an embodiment of a forward clock network.

FIG. 3 is a block diagram depicting an embodiment of a backward clock network.

FIG. 4 is a block diagram depicting an embodiment of a control circuit for a power transient detection subsystem.

FIG. 5 is a block diagram depicting an embodiment of a phase comparator circuit.

FIG. 6 is a block diagram depicting a different embodiment of a control circuit for a power transient detection subsystem.

FIG. 7 is a block diagram depicting an embodiment of a phase generator circuit.

FIG. 8 is a block diagram depicting a different embodiment of a phase generator circuit.

FIG. 9 is a block diagram depicting an embodiment of an injection-locked oscillator circuit.

FIG. 10 is a block diagram depicting an embodiment of a multi-stage phase blender circuit.

FIG. 11 is a block diagram depicting an embodiment of a blend circuit.

FIG. 12 is a block diagram depicting a different embodiment of a computer system.

FIG. 13 is a flow diagram depicting an embodiment of a method for detecting power supply voltage transients.

FIG. 14 is a block diagram of an embodiment of a device that may include receiver circuits.

FIG. 15 is a block diagram of various embodiments of computer systems that may include clock subsystem.

FIG. 16 illustrates an example of a non-transitory computer-readable storage medium that stores circuit design information.

### DETAILED DESCRIPTION

Computer systems can include a variety of circuits that operate using different power supply voltage levels. For example, in order to provide sufficient operating head room, analog/mixed-signal circuits may employ a higher power supply voltage than high-speed logic circuits. To provide such different power supply voltage levels, computer systems may include multiple power converter or voltage regulator circuits that are configured to generate various power supply voltages.

A power distribution network is employed to distribute the different power supply voltages to the circuits in a computer system. Such networks may include a grid or mesh of metal wires to which power terminals of the circuits in the computer system are coupled. The grid or mesh may be on a circuit board or other suitable substrate. In the case of a system-on-a-chip (or “SoC”), the metal wires included in the grid or mesh may be fabricated on a single integrated circuit along with the circuits of the SoC.

During operation of a computer system, different circuit blocks can draw respective currents from the power distribution network. In some SoC devices, simultaneous switching of multiple logic circuits, or transitions between power states, can generate rapid current changes with respect to time (referred to as “di/dt events”). Such rapid current transients can cause localized drops in the voltage level of a power distribution network (referred to as “power supply droop”) due to parasitic resistance and inductances in the wiring of the power distribution network.

Localized drops in the voltage level of a power distribution network can affect the operation of circuits drawing power from the power distribution network. As the voltage level drops, some circuits may cause timing violations within a logic circuit causing latch or flip-flop circuits to capture and propagate incorrect logic values.

Various techniques may be employed to reduce power supply voltage droops. For example, in some cases, the overall operating speed of a computer system may be reduced or the power supply voltage increased. This, however, may be at odds with power, performance, and latency requirements for the computer system. Alternatively, capacitors may be coupled between different points of a power distribution network and a ground supply node. Such capacitors (sometimes referred to as “decoupling capacitors”) can provide localized energy storage to provide extra current during di/dt events, thereby reducing power supply droop. Decoupling capacitors can add extra area and cost to a computer system. Such capacitors need to be physically in proximity to circuits experiencing a di/dt event, and need time to recharge after such an event, which significantly limits their effectiveness in high-performance systems.

The embodiments illustrated in the drawings and described below provide techniques for detecting drops in power supply voltages and mitigation for some of the effects of such drops in power supply voltages while minimizing performance and power impact. By monitoring distributed clock signals, changes in the respective phases of such signals relative to one or more signals at a clock generation circuit can be used to determine when a clock distribution network is slowing down due to a decrease in power supply voltage. The phase information may additionally be used to adjust the clock generation circuit so that timing issues in logic circuits are minimized during a drop in power supply voltage.

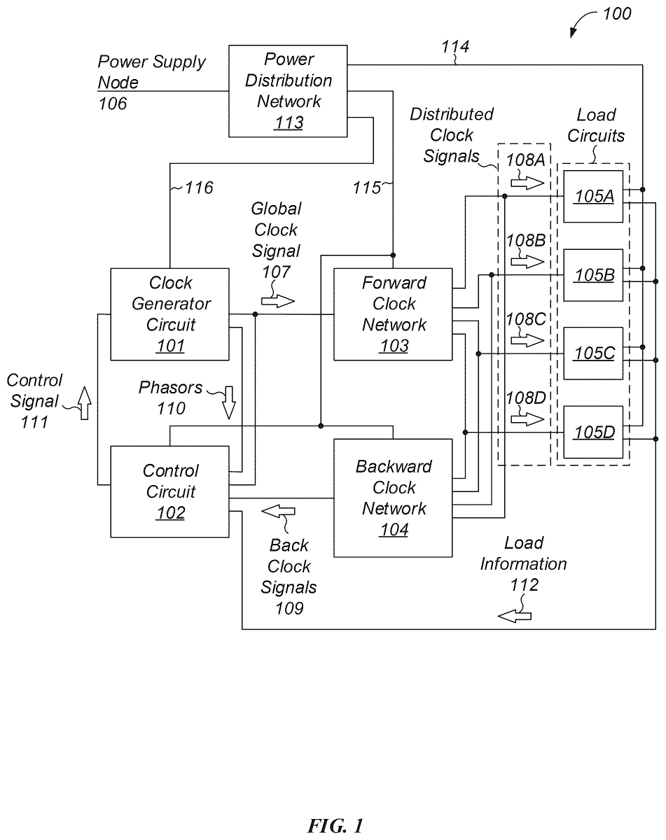

A block diagram of a computer system is depicted in FIG. 1. As illustrated, computer system 100 includes clock generator circuit 101, control circuit 102, forward clock network 103, backward clock network 104, load circuits 105A-105D, and power distribution network 113. In various embodiments, clock generator circuit 101, control circuit 102, forward clock network 103, and backward clock network 104 may form a power transient detection subsystem that uses changes in the phase difference between global clock signal 107 and distributed clock signals 108A-108D to determine transients in the voltage levels of nodes 115 and 114.

Power distribution network 113 is coupled to power supply node 106 and is configured to distribute power from power supply node 106 to nodes 114, 115, and 116. In various embodiments, power distribution network 113 may be implemented as a mesh or grid of metal wires fabricated on one or more metal layers available in a semiconductor manufacturing process and may contain active regulator circuits. Although power distribution network 113 is depicted as distributing power from power supply node 106 to three nodes, in other embodiments, power distribution network 113 may be configured to distribute power to any suitable number of nodes. It is noted that power supply node 106 may be coupled to an external power supply or to an internal power converter circuit, a voltage regulator circuit, or a battery.

Clock generator circuit 101 is coupled to node 116 and is configured to generate global clock signal 107. In some embodiments, clock generator circuit 101 may be further configured to generate one or more phasors (denoted as “phasors 110”). In such cases, phasors 110 may be periodic signals with a frequency the same as the frequency of global clock signal 107, but with different phase delays from global clock signal 107. It is noted that the respective phases of some of phasors 110 may lag the phase of global clock signal 107. In some embodiments, the respective phases of others of phasors 110 may lead the phase of global clock signal 107 to allow for the detection of power supply voltage overshoot conditions.

In various embodiments, clock generator circuit 101 may be implemented using one or more phase-locked loop (PLL) circuits, delay-locked loop (DLL) circuits, or any other suitable type of frequency synthesis circuits. In some embodiments, clock generator circuit 101 may be supplied with a reference clock signal (not shown) generated by a crystal oscillator circuit or supplied by a circuit external to computer system 100. In other embodiments, clock generator circuit 101 may be configured to employ multiplying or injector-locked oscillator techniques to generate phasors 110.

Forward clock network 103 is configured, using a voltage level of node 115, to distribute global clock signal 107 to distributed clock signals 108A-108D. As described below, forward clock network 103 may include a clock mesh, clock tree, or grid along with multiple buffer circuits coupled to node 115. In some embodiments, forward clock network 103 may include clock gating circuits. Although forward clock network 103 is depicted as generating four distributed clock signals, in other embodiments, forward clock network 103 may be configured to generate any suitable number of distributed clock signals. In synchronous systems, such distributed clock signals may be designed to have low skew between the final point of the different clock signals, e.g. 105A-D in this example. In various embodiments, a voltage droop or noise on node 115 resulting from a di/dt event can cause the multiple buffer circuits in forward clock network 103 to operate more slowly, increasing a phase difference between global clock signal 107 and back clock signals 109.

Load circuits 105A-105D are coupled to node 114 and respective ones of distributed clock signals 108A-108D. In various embodiments, load circuits 105A-105D may include any suitable combination of processor circuits, memory circuits, analog/mixed-signal circuits, input/output circuits, and the like. Although only four load circuits are depicted in the embodiment of FIG. 1, in other embodiments, any suitable number of load circuits may be included in computer system 100.

As logic circuits included in load circuits 105A-105D switch, i.e., change their respective output values, the logic circuits draw current from power supply node 106 through power distribution network 113 and node 114. In some cases, when a threshold number of logic gates switch at substantially the same time (referred to as “simultaneous switching”), the corresponding current demand can result in voltage drops across parasitic inductances and resistances included in the wiring of power distribution network 113. Such voltage drops can result in voltage transients on nodes 114 and 115 that can affect the operation of load circuits 105A-105D, as well as the circuits included in forward clock network 103 and backward clock network 104, which can increase a phase difference between global clock signal 107 and distributed clock signals 108A-108D. It is noted that other events, such as un-gating clock signals, transitioning between power states, data stalls, enabling or disabling of cores or other blocks, or even a shift in instruction set mix can also cause power transients.

In some embodiments, load circuits 105A-105D may be configured to generate load information 112, which may be used by control circuit 102 to generate control signal 111. In some cases, load information 112 can include a number of active sub-circuits included in load circuits 105A-105D. In some cases, a processor circuit included in load circuits 105A-105D may include a prediction of future activity in load information 112. Such a prediction may, in some embodiments, be based on an analysis of instructions stored in an instruction fetch buffer, a number of instructions being speculatively fetched from a memory circuit, or any other suitable instruction-oriented information.

Backward clock network 104 is configured to select at least one of distributed clock signals 108A-108D to generate back clock signals 109. As described below, backward clock network 104 may include multiple multiplex circuits and buffer circuits coupled to node 115.

Control circuit 102 is configured to perform a phase comparison between global clock signal 107 of phasors 110 and at least one of back clock signals 109. In various embodiments, control circuit 102 may be configured to generate control signal 111 which may, in different embodiments, encode a result of the phase comparison. It is noted that a magnitude of the change in the phase difference between global clock signal 107 and the at least one of back clock signals 109 over a period of one or more clock cycles or phases may be indicative of a magnitude of a voltage droop on node 115. In some cases, a duration of the voltage droop on node 115 may be determined using a duration of an increase in the phase difference between global clock signal 107 and the at least one of back clock signals 109 before the phase difference returns to a nominal value. Although control signal 111 is depicted as a single wire, in other embodiments, control signal 111 may include multiple bits transmitted using respective wires or metal traces.

In some embodiments, control circuit 102 may be further configured to generate control signal 111 using load information 112 in conjunction with the result of the phase comparison. Additionally, or alternatively, control circuit 102 may be configured to perform respective phase comparisons between one or more of back clock signals 109 and phasors 110 to generate control signals 111.

In various embodiments, clock generator circuit 101 is further configured to modify global clock signal 107 using a result of at least one of the phase comparisons performed by control circuit 102. In some cases, the result of the at least one phase comparison may be transmitted to clock generator circuit 101 by control circuit 102 using control signal 111. In some embodiments, to modify global clock signal 107, clock generator circuit 101 may be further configured to temporarily decrease a frequency of global clock signal 107. In various embodiments, to decrease the frequency of global clock signal 107, clock generator circuit 101 may be further configured to perform cycle skipping, slewing, or any other suitable operation that eliminates one or more clock pulses over a predetermined period of time. Alternatively, or additionally, clock generator circuit 101 may be configured to phase shift global clock signal 107 using the result of the at least one phase comparison.

In various embodiments, clock generator circuit 101 may be additionally configured to adjust the frequency of global clock signal 107 and/or phasors 110 based on any suitable combination of the voltage level of power supply node 106, an operating mode of computer system 100, process-related parameters, e.g., transistor threshold voltages, of computer system 100, and the like.

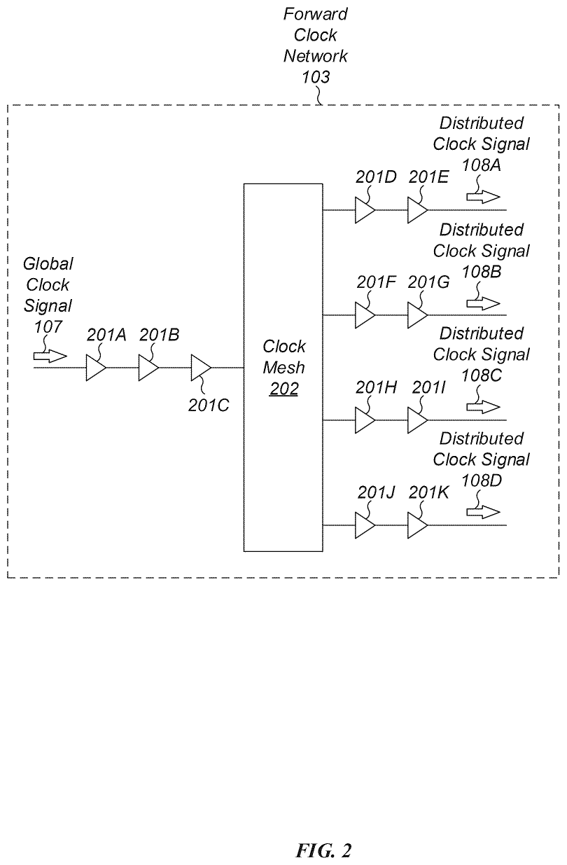

Turning to FIG. 2, a block diagram of an embodiment of forward clock network 103 is depicted. As illustrated, forward clock network 103 includes buffer circuits 201A-201K and clock mesh 202. Although the embodiment of FIG. 2 depicts the use of 11 buffer circuits, in other embodiments, forward clock network 103 may include any suitable number of buffer circuits.

Buffer circuit 201A is configured to generate a buffered version of global clock signal 107, which is, in turn, buffered by buffer circuits 201B and 201C to drive clock mesh 202. In various embodiments, clock mesh 202 may be implemented using a grid or mesh of wires to connect an output of buffer circuit 201C to respective inputs of multiple buffer circuits, e.g., 201D. In different embodiments, an architecture of clock mesh 202 may be based on a desired number of distributed clock signals. For example, in the embodiment of FIG. 2, clock mesh 202 is configured to have four outputs that are used to generate distributed clock signals 108A-108D. It is noted that, in some embodiments, clock mesh 202 may be distributed over all or part of an integrated circuit to deliver buffered versions of global clock signal 107 to corresponding portions of the integrated circuit. In some embodiments, a “clock tree” topology may also be employed for some elements.

Buffer circuit 201D buffers an output of clock mesh 202, which is, in turn, buffered by buffer circuit 201E to generate distributed clock signal 108A. In a similar fashion, buffer circuits 201F and 201G are configured to generate distributed clock signal 108B, buffer circuits 201H and 201I are configured to generate distributed clock signal 108C, and buffer circuits 201J and 201K are configured to generate distributed clock signal 108D.

Buffer circuits 201A-201K may be implemented using inverter logic gates, pairs of inverter logic gates, or any suitable non-inverting amplifier circuits. In various embodiments, buffer circuits 201A-201K may include one or more metal-oxide semiconductor field-effect transistors (MOSFETs), fin field-effect transistors (FinFETs), gate-all-around field-effect transistors (GAAFETs), or any suitable transconductance devices. In some embodiments, such transistors may be low-threshold transistors.

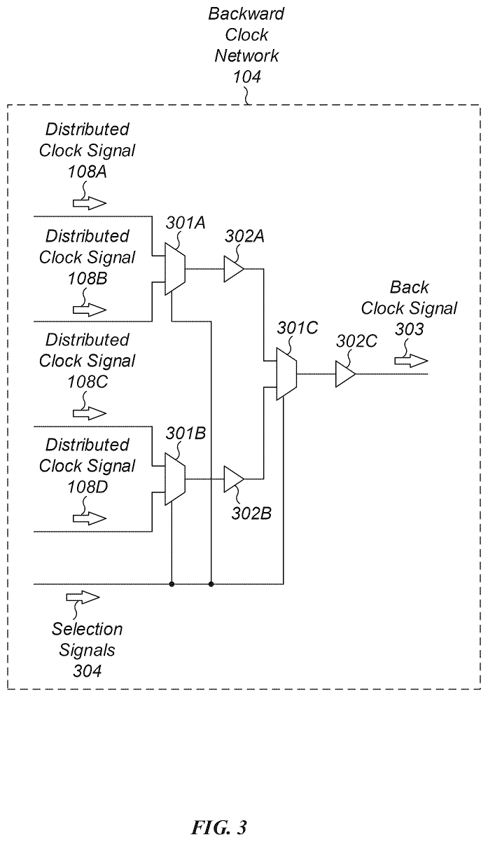

Turning to FIG. 3, a block diagram of an embodiment of backward clock network 104 is depicted. As illustrated, backward clock network 104 includes multiplex circuits 301A-301C, and buffer circuits 302A-302C.

Multiplex circuit 301A is configured to select one of distributed clock signal 108A and distributed clock signal 108B using selection signals 304. Buffer circuit 302A is configured to buffer an output of multiplex circuit 301A. In a similar fashion, multiplex circuit 301B is configured to select one of distributed clock signal 108C and distributed clock signal 108D using selection signals 304, and buffer circuit 302B is configured to buffer an output of multiplex circuit 301B.

Multiplex circuit 301C is configured to select one of an output of buffer circuit 302A and an output of buffer circuit 302B using selection signals 304. Buffer circuit 302C is configured to buffer an output of multiplex circuit 301C to generate back clock signal 303.

Although backward clock network 104 is depicted as generating a single back clock signal, in other embodiments, additional multiplex circuits and buffer circuits may be employed to generate multiple back clock signals. It is noted that although the multiplex circuits and buffer circuits included in backward clock network 104 are depicted as being in a common circuit block, in some embodiments, multiplex circuits 301A-301C and buffer circuits 302A-302C may be located in respective locations across an integrated circuit or SoC. By generating multiple back clock signals from distributed clock signals located at different locations within an integrated circuit or SoC, the impact of local droop events is thus felt by local elements of forward clock network 103 and backward clock network 104. Control circuit 102 can use such location information to determine how to adjust global clock signal 107.

In various embodiments, multiplex circuits 301A-301C may be implemented using any suitable combination of logic gates such that the combination implements the multiplex function. In other embodiments, multiplex circuits 301A-301C may be implemented using multiple transmission gate circuits connected together, using restoring logic gates such as buffers, and controlled by selection signals such as selection signals 304.

In some embodiments, selection signals 304 may be static signals whose values are set during a post-manufacture test operation. Alternatively, or additionally, selection signals 304 may be changed during operation of computer system 100. In various embodiments, values for selection signals 304 may be relayed to multiplex circuits 301A-301C using Joint Test Action Group (JTAG) scan test interface or any other suitable test interface.

In various embodiments, buffer circuits 302A-302C may be implemented using any suitable inverting or non-inverting amplifier circuits. In other embodiments, buffer circuits 302A- 302C may be implemented using an even number of inverters or other suitable logic circuits. In such cases, the respective fanouts of the inverters may be substantially the same to preserve rise and fall times of the edges of distributed clock signals 108A-108D. In some embodiments, the design of backward clock network 104 may be tuned to increase sensitivity to power supply noise by adjusting the type of transistors used, their fanout/loading, or physical placement in the back-propagation path.

In some embodiments, buffer circuits 302A-302C may include one or more MOSFETs, FinFETs, GAAFETs, or any other suitable transconductance devices. In other embodiments, respective threshold voltages of transistors included in buffer circuits 302A-302C may be greater than threshold voltages included in buffer circuits 201A-201K.

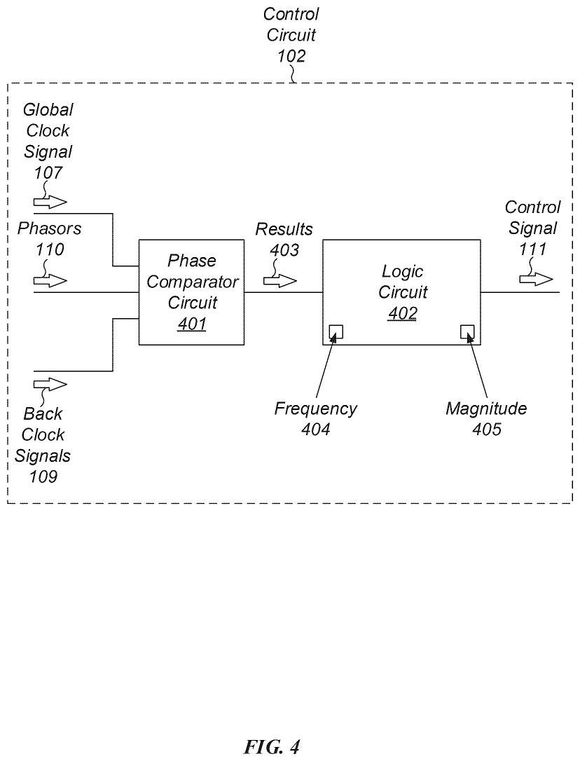

Turning to FIG. 4, a block diagram of an embodiment of control circuit 102 is depicted. As illustrated, control circuit 102 includes phase comparator circuit 401 and logic circuit 402.

Phase comparator circuit 401 is configured to generate results 403 using global clock signal 107 and back clock signals 109. In some embodiments, phase comparator circuit 401 may be further configured to generate results 403 using phasors 110 along with global clock signal 107 and back clock signals 109.

In some embodiments, to generate results 403, phase comparator circuit 401 may be configured to perform a phase comparison between global clock signal 107 and at least one of back clock signals 109. In other embodiments, phase comparator circuit 401 may be further configured to perform multiple phase comparisons between different ones of phasors 110 and at least one of back clock signals 109. In cases where multiple phase comparisons are performed, results 403 may include data indicative of individual ones of the phase comparisons.

As described below, phase comparator circuit 401 may include multiple phase detector circuits. In various embodiments, different ones of the multiple phase detector circuits may be configured to perform phase comparisons between different ones of phasors 110 and back clock signals 109, and a memory of any kind can store a history of such comparisons to notate the changes in phase comparison over time.

Logic circuit 402 is configured to generate control signal 111 using results 403. In various embodiments, logic circuit 402 may be configured to determine frequency 404 and magnitude 405 of a power supply voltage transient (or “droop”) using results 403. For example, a duration of an increase in the phase difference between global clock signal 107 and back clock signals 109 can be used to determine frequency 404, while a magnitude of the phase difference can be used to determine magnitude 405. In some embodiments, logic circuit 402 may include information indicative of frequency 404 and magnitude 405 of the power supply voltage transient in control signal 111, which can be used to trigger a temporary downshift in frequency, or clock skipping as described above. In some embodiments, logic circuit 402 may be further configured to determine a time rate of change of the phase difference, which can be used in the generation of control signal 111. As described below, such frequency and magnitude information may be used by a power circuit to adjust a voltage level of power supply node 106 or the respective distributed voltages of nodes, e.g., node 115, node 116, etc. It is noted that although control signal 111 is depicted as a single wire, in other embodiments, control signal 111 may include multiple wires encoding multiple bits of information.

Logic circuit 402 may be implemented as a general-purpose processor, microcontroller, or any other suitable processor circuit. In some embodiments, logic circuit 402 may be implemented as a state machine or any other suitable sequential logic circuit.

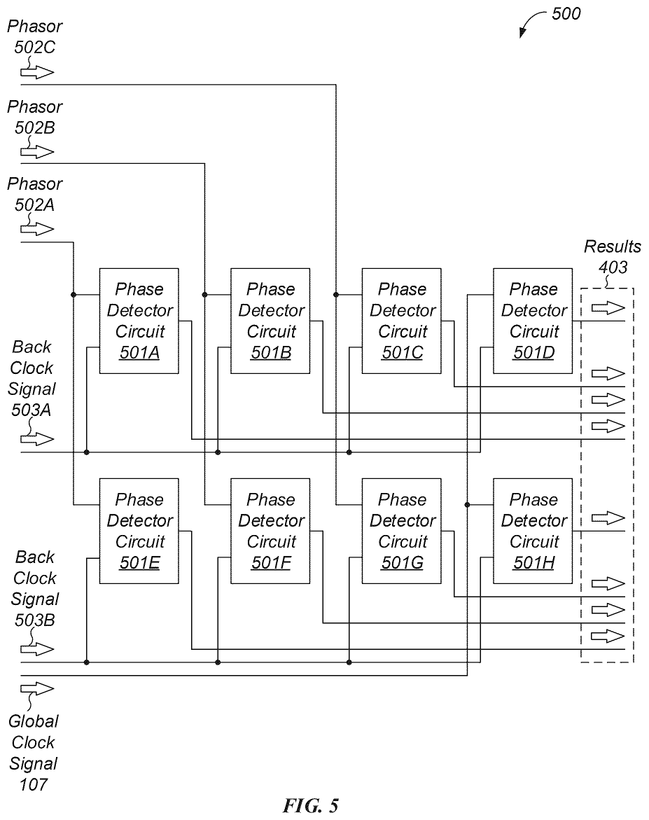

Turning to FIG. 5, a block diagram of an embodiment of a phase comparator circuit is depicted. In various embodiments, phase comparator circuit 500 may correspond to phase comparator circuit 401 as depicted in FIG. 4. As illustrated, phase comparator circuit 500 includes phase detector circuits 501A-501H. Although 8 phase detector circuits are depicted in the embodiment of FIG. 5, in other embodiments, phase comparator circuit 500 may employ any suitable number of phase detector circuits.

Phase detector circuit 501A is configured to generate a corresponding one of results 403 using back clock signal 503A and phasor 502A, and phase detector circuit 501B is configured to generate a corresponding one of results 403 using back clock signal 503A and phasor 502B. In a similar fashion, phase detector circuit 501C is configured to generate a corresponding one of results 403 using back clock signal 503A and phasor 502C, and phase detector circuit 501D is configured to generate a corresponding one of results 403 using back clock signal 503A and global clock signal 107. In various embodiments, phasors 502A-502C may be included in phasors 110, and back clock signals 503A-503B may be included in back clock signals 109.

Phase detector circuit 501E is configured to generate a corresponding one of results 403 using back clock signal 503B and phasor 502A, and phase detector circuit 501F is configured to generate a corresponding one of results 403 using back clock signal 503B and phasor 502B. In a similar fashion, phase detector circuit 501G is configured to generate a corresponding one of results 403 using back clock signal 503B and phasor 502C, and phase detector circuit 501H is configured to generate a corresponding one of results 403 using back clock signal 503B and global clock signal 107.

In different embodiments, phase detector circuits 501A-501H may encode corresponding ones of results 403 with information indicative of a magnitude of a phase delay between their respective back clock signals and a reference signal. For example, phase detector circuit 501A may encode its corresponding one of results 403 with information indicative of the phase delay between back clock signal 503A and phasor 502A. As described above, such phase delay information, or changes in the phase delay information, may be used to determine a magnitude and a frequency of a power supply voltage transient within a computer system. In some cases, by using results from different back clock signals from different locations in the computer system, the location of power supply voltage transients may also be determined.

To determine the phase delay between a back clock signal and a corresponding reference signal, a particular one of phase detector circuits 501A-501H may compare a rising edge of the back clock signal to a rising edge of the reference signal. For example, phase detector circuit 501A may be configured to compare a rising edge of back clock signal 503A to a rising edge of phasor 502A. In other embodiments, phase detector circuits 501A-501H may be configured to compare falling edges of their respective back clock signals and reference signals. In some embodiments, some of phase detector circuits 501A-501H may compare rising edges, while others of phase detector circuits 501A-501H may compare falling edges.

In various embodiments, phase detector circuits 501A-501H may be implemented using an exclusive-OR circuit, one or more flip-flop circuits, a Mueller-Muller phase detector circuit, a bang-bang phase detector circuit, or any other suitable type of phase detector circuit.

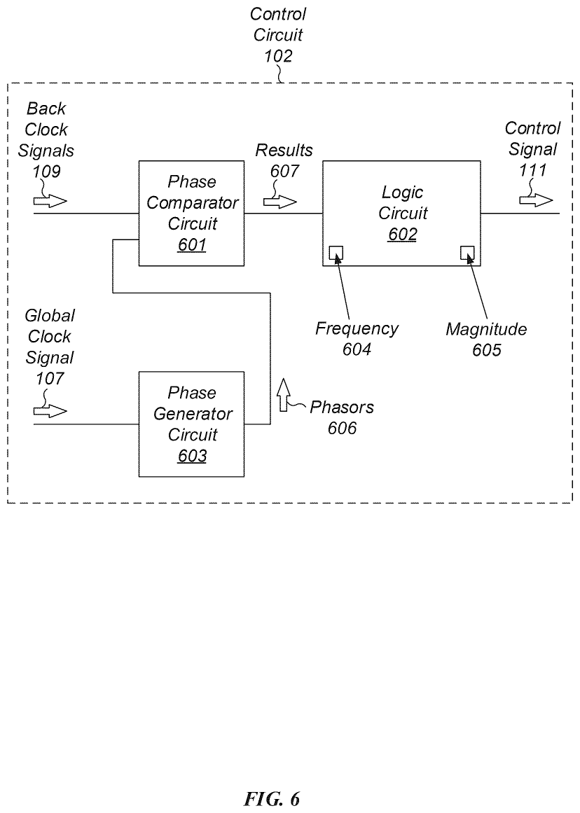

Turning to FIG. 6, a block diagram of another embodiment of control circuit 102 is depicted. As illustrated, control circuit 102 includes phase comparator circuit 601, logic circuit 602, and phase generator circuit 603.

Phase comparator circuit 601 is configured to generate results 607 using phasors 606 and back clock signals 109. In some embodiments, phase comparator circuit 601 may correspond to phase comparator circuit 401.

In some embodiments, to generate results 607, phase comparator circuit 601 may be configured to perform a phase comparison between at least one of back clock signals 109 and different ones of phasors 606. In cases where multiple phase comparisons are performed, results 607 may include data indicative of individual ones of the phase comparisons.

As described below, phase comparator circuit 601 may include multiple phase detector circuits. In various embodiments, different ones of the multiple phase detector circuits may be configured to perform phase comparisons between different ones of phasors 606 and back clock signals 109, and a history of such comparisons.

Logic circuit 602, which may correspond to logic circuit 402 in some embodiments, is configured to generate control signal 111 using results 607. In various embodiments, logic circuit 602 may be configured to determine frequency 604 and magnitude 605 of a power supply voltage transient (or “droop”) using results 607. Similarly, a transient in the other direction (or “spike”) can be also determined by movement in the other direction. For example, a duration of an increase in the phase difference between global clock signal 107 and back clock signals 109 can be used to determine frequency 604, while a magnitude of the phase difference can be used to determine magnitude 605. In some embodiments, logic circuit 602 may include information indicative of frequency 604 and magnitude 605 of the power supply voltage transient in control signal 111, which can be used to trigger a temporary downshift in frequency, or clock skipping or slewing as described above. In some embodiments, logic circuit 602 may be further configured with a memory or other method to determine a time rate of change of the phase difference, which can be used in the generation of control signal 111. As described below, such frequency and magnitude information may be used by a power circuit to adjust a voltage level of power supply node 106 or the respective distributed voltages of nodes, e.g., node 115, node 116, etc. It is noted that although control signal 111 is depicted as a single wire, in other embodiments, control signal 111 may include multiple wires encoding multiple bits of information.

Logic circuit 602 may be implemented as a general-purpose processor, microcontroller, or any other suitable processor circuit. In some embodiments, logic circuit 602 may be implemented as a state machine or any other suitable sequential logic circuit.

Phase generator circuit 603 is configured to generate phasors 606 using global clock signal 107. As described below, phase generator circuit 603 may include an injection-locked loop circuit configured to generate multiple phase signals and one or more phase blender circuits configured to combine different ones of the multiple phase signals to generate different ones of phasors 606.

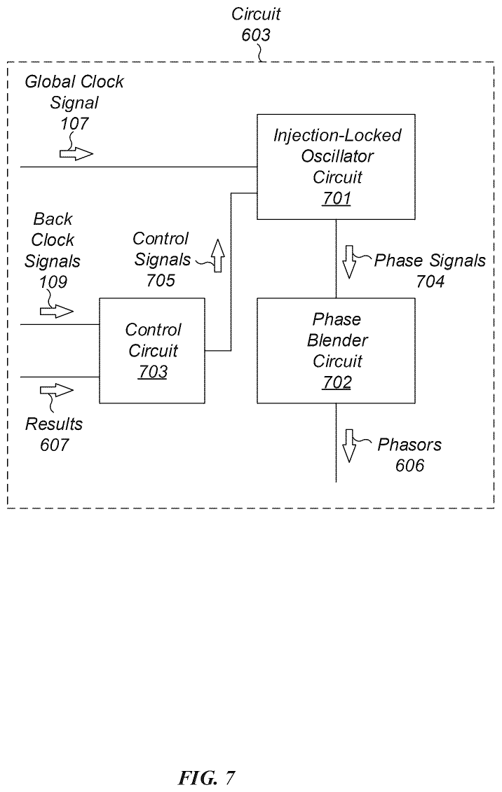

Turning to FIG. 7, a block diagram of an embodiment of phase generator circuit 603 is depicted. As illustrated, phase generator circuit 603 includes injection-locked oscillator circuit 701, phase blender circuit 702, and control circuit 703.

Injection-locked oscillator circuit 701 is configured to generate phase signals 704 using global clock signal 107 and control signals 705. As described below, injection-locked oscillator circuit 701 may include a ring oscillator circuit configured to generate phase signals 704. In various embodiments, the frequency of the ring oscillator circuit may be controlled by coupling delayed versions of global clock signal 107 into corresponding stages of the ring oscillator circuit. In some embodiments, a number of stages of the ring oscillator circuit that receive a corresponding signal injection is governed by control signals 705.

Phase blender circuit 702 is configured to generate phasors 606 using phase signals 704. To generate phasors 606, phase blender circuit 702 may be configured to combine two or more of phase signals 704 to generate a given one of phasors 606. As described below, phase blender circuit 702 may include multiple stages of blend circuits to allow for both a coarse grain and fine grain range of phases in phasors 606.

Control circuit 703 is configured to generate control signals 705 using back clock signals 109 and results 607. In various embodiments, control circuit 703 may be configured to perform a phase comparison between at least one of back clock signals 109 and at least one of results 607. In some embodiments, control circuit 703 may include at least one phase detector circuit along with a logic circuit configured to generate control signals 705 based on an output from the at least one phase detector circuit.

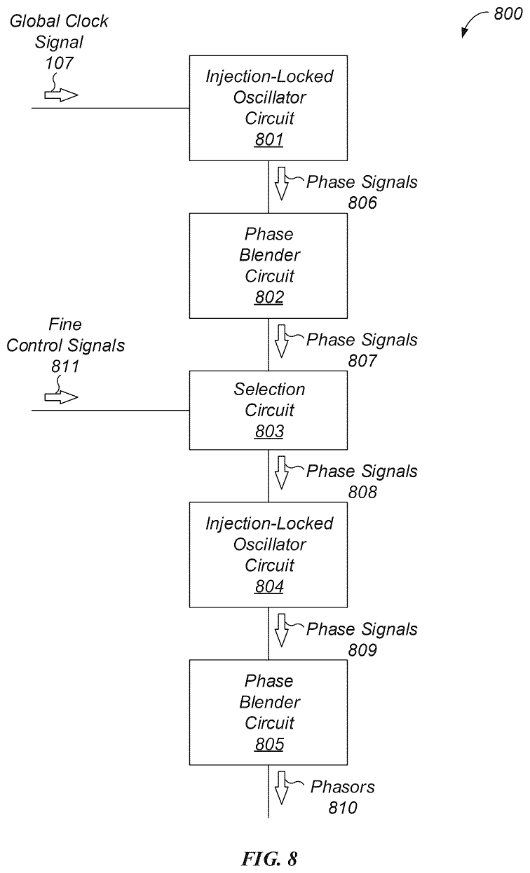

In some cases, multiple injection-locked oscillator circuits and phase blender circuits can be used to implement a coarse-fine architecture. Such an architecture can allow for large phase jumps between the global clock signal and the back clock signals, while still providing a fine resolution for situations where the phase difference between the global clock signal and the back clock signals is near zero. An embodiment of a phase generator circuit with a coarse-fine architecture is depicted in FIG. 8. As illustrated, phase generator circuit 800 includes injection-locked oscillator circuits 801 and 804, phase blender circuits 802 and 805, and selection circuit 803.

Injection-locked oscillator circuit 801 is configured to generate phase signals 806 using global clock signal 107. In various embodiments, injection-locked oscillator circuit 801 may be implemented in a fashion similar to injection-locked oscillator circuit 701 as depicted in FIG. 7.

Phase blender circuit 802 is configured to generate phase signals 807 using phase signals 806. In various embodiments, phase blender circuit 802 can be implemented in a fashion similar to phase blender circuit 702 as depicted in FIG. 7.

Selection circuit 803 is configured to generate phase signals 808 using phase signals 807 and fine control signals 811. To generate phase signals 808, selection circuit 803 is configured to select at least one of phase signals 807 based on fine control signals 811. In various embodiments, a value of fine control signals 811 may be based on a current value or a history of voltage droop within a computer system power supply network. In some cases, different workloads for the computer system can be used to determine the value of fine control signals 811. In various embodiments, selection circuit 803 may be implemented using one or more multiplex circuits.

Injection-locked oscillator circuit 804 is configured to generate phase signals 809 using phase signals 808. Like injection-locked oscillator circuit 801, injection-locked oscillator circuit 804 may be implemented in a similar fashion to injection-locked oscillator circuit 701 as depicted in FIG. 7.

Phase blender circuit 805 is configured to generate phasors 810 using phase signals 809. In various embodiments, phasors 810 may correspond to phasors 606 as depicted in FIG. 6. In some embodiments, phase blender circuit 805 may be implemented in a fashion similar to phase blender circuit 702 as depicted in FIG. 7.

It is noted that control circuits for injection-locked oscillator circuits 801 and 804 have been omitted for clarity. In various embodiments, such control circuits would provide respective control signals for injection-locked oscillator circuits 801 and 804 in a fashion similar to that of control circuit 703 as depicted in FIG. 7.

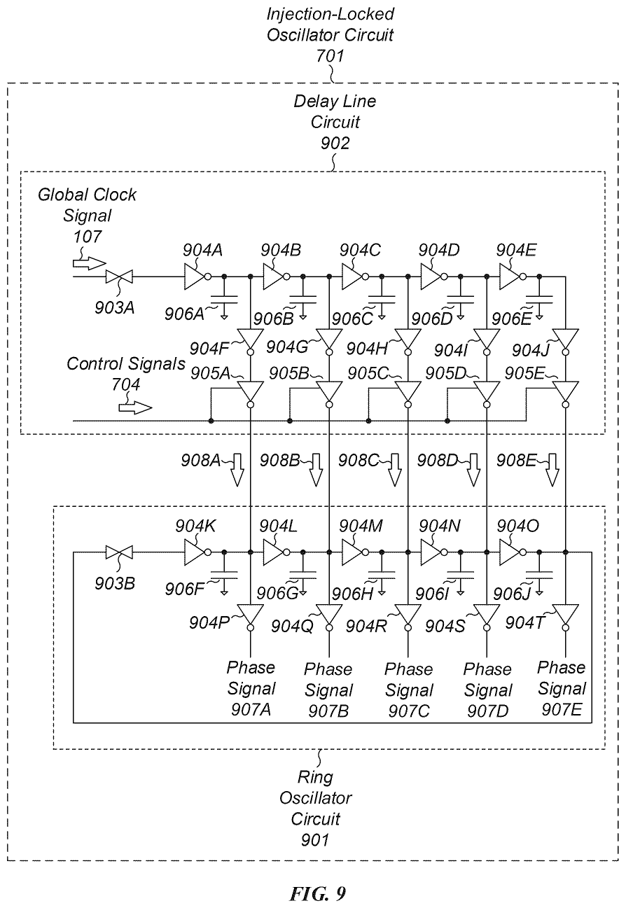

Turning to FIG. 9, a block diagram of an embodiment of injection-locked oscillator circuit 701 is depicted. As illustrated, injection-locked oscillator circuit 701 includes ring oscillator circuit 901 and delay line circuit 902.

In various embodiments, ring oscillator circuit 901 includes inverters 904K-904T, pass gate circuit 903B, and capacitors 906F-906J. Inverters 904K-904O, along with pass gate 903B, are arranged in a daisy-chain fashion to form a ring oscillator circuit. In various embodiments, pass gate circuit 903B may be placed in an “open state” to disable ring oscillator circuit 901 by preventing feedback from the output of inverter 904O to the input of inverters 904K. Although ring oscillator circuit 901 is depicted as including 5 stages, in other embodiments, any suitable number of stages may be employed.

Capacitors 906F-906J are coupled between corresponding outputs of inverters 904K-904O a ground supply node. In various embodiments, the values of capacitors 906F-906J may be selected to adjust respective slew rates of signals generated by inverters 904K-904O. The output of inverters 904K-904O are coupled to corresponding inputs of inverters 904P-904T, which are configured to generate phase signals 907A-907E, respectively. In various embodiments, phase signals 907A-907E may be included in phase signals 704 as depicted in FIG. 7.

Delay line circuit 902 includes pass gate circuit 903A, inverters 904A-904J, gated inverters 905A-905E, and capacitors 906A-906E. Pass gate circuit 903A is coupled to an input of inverter 904A and is configured to pass global clock signal 107 to the input of inverter 904A. In various embodiments, pass gate circuit 903A may be placed in an “open” state to prevent global clock signal 107 from reaching the input of inverter 904A, thereby preventing inverters 904A-904E from toggling. Although delay line circuit 902 is depicted as including 5 stages, in other embodiments, any suitable number of stages may be employed.

Inverters 904A-904E are coupled in series with capacitors 906A-906E which are coupled between corresponding outputs of inverters 904A-904E and the ground supply node. In various embodiments, the values of capacitors 906A-906E may be selected to adjust respective slew rates of signals generated by inverters 904A-904E.

Inputs of inverters 904F-904J are coupled to outputs of inverters 904A-904E, respectively. Outputs of inverters 904F-904J are coupled to inputs of gated inverters 905A-905E, which are configured to generate signals 908A-908E. In various embodiments, individual ones of gated inverters 905A-905E can be activated and deactivated by corresponding ones of control signals 704. By selectively activating and deactivating gated inverters 905A-905E, different ones of signals 908A-908E can be injected into corresponding nodes of ring oscillator circuit 901, locking the frequency of ring oscillator circuit 901 to a frequency of global clock signal 107. It is noted that when deactivated, gated inverter circuits 905A-905E can enter a high output impendance state.

In various embodiments, capacitors 906A-906J may be implemented using metal-oxide-metal (MOM) capacitor structures, metal-insulator-metal (MIM) structures, or any other suitable capacitor structure available on a semiconductor manufacturing process.

Inverters 904A-904T and gated inverters 905A-905E may, in various embodiments, be implemented using complementary metal-oxide semiconductor (CMOS) inverter gates, or any other suitable inverting amplifier circuits, including those implemented using technologies other than CMOS.

A block diagram of an embodiment of a multi-stage phase blender circuit is depicted. As illustrated, phase blender circuit 1000 includes blend circuits 1001-1007. In various embodiments, phase blender circuit 1000 may be included in phase blender circuit 702 as depicted in the embodiment of FIG. 7. Although phase blender circuit 1000 is depicted as including 3 stages, in other embodiments, phase blender circuit 1000 can include any suitable number of stages. For example, phase blender circuit 1000 is configured to generate 9 output phases using 2 input phases. Other possible configurations include a 2-stage phase blender circuit configured to generate 5 output phases using 2 input phases, a 1-stage phase blender circuit configured to generate 3 output phases using 2 input phases, a load-stage phase blender circuit configured to generate 2 output phases using 2 input phases, and any other suitable number of stages.

Blend circuit 1001 is configured to use phase signals 1008 and 1009 to generate signals 1010, 1011, and 1012. It is noted that phase signals 1008 and 1009 may be included in phase signals 704. In various embodiments, the phase of signal 1012 may be in between the phases of signals 1010 and 1011.

Blend circuit 1002 is configured to generate signals 1013-1015 using signals 1010 and 1012. In a similar fashion, blend circuit 1003 is configured to generate signals 1017 and 1018 using signals 1011 and 1012. It is noted that one output of blend circuit 1003 is not used (denoted as “no connect 1016”).

Blend circuit 1004 is configured to generate three of phasors 1019 using signals 1013 and 1015. Blend circuit 1005 is configured to generate two of phasors 1019 using signals 1014 and 1015, while blend circuit 1006 is configured to generate two of phasors 1019 using signals 1014 and 1018. Blend circuit 1007 is configured to generate two of phasors 1019 using signals 1017 and 1018. It is noted that one output of each of blend circuits 1005-1007 are not used (denoted as “no connect 1020, no connect 1021, and no connect 1022,” respectively).

In various embodiments, one or more load circuits (not shown for clarity) may be employed in phase blender circuit 1000. In such cases, a given load circuit of the one or more load circuits may be coupled to different ones of blend circuits 1001-1007 to make each of blend circuits 1001-1007 have substantially the same load.

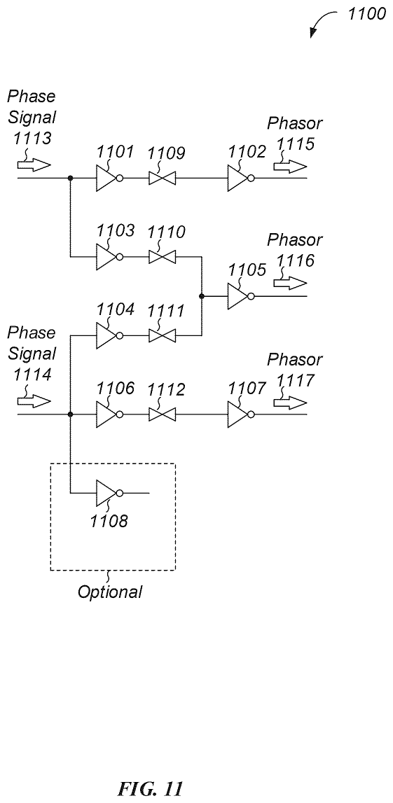

Turning to FIG. 11, a block diagram of an embodiment of a blend circuit is depicted. As illustrated, blend circuit 1100 includes inverters 1101-1108, and pass gate (also referred to as “transmission gate”) circuits 1109-1112. In various embodiments, blend circuit 1100 may correspond to any of blend circuits 1001-1007 as depicted in the embodiment of FIG. 1000.

Pass gate circuit 1109 is coupled between inverter 1101 and inverter 1102, and pass gate circuit 1112 is coupled between inverter 1106 and inverter 1107. In a similar fashion, pass gate circuit 1110 is coupled between inverter 1103 and inverter 1105, while pass gate circuit 1111 is coupled between inverter 1104 and inverter 1105.

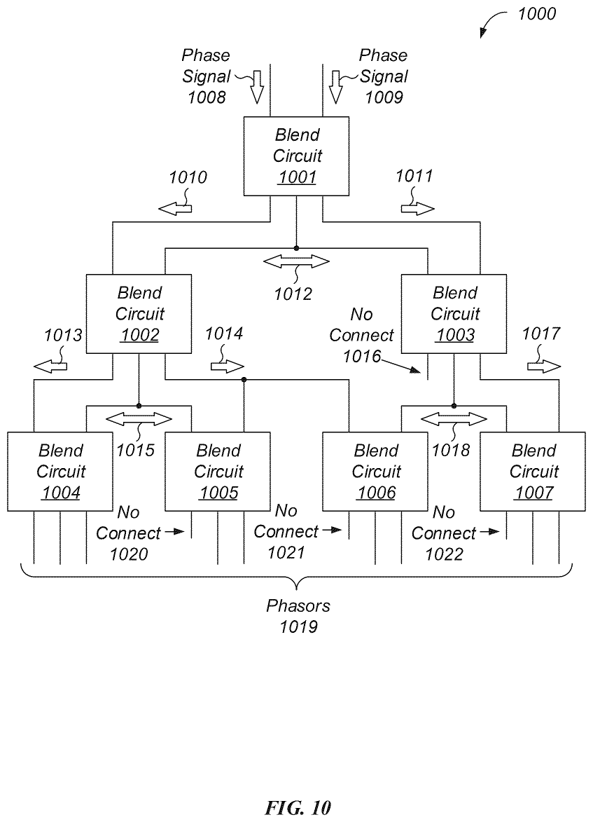

Inverters 1101 and 1103 are configured to receive phase signal 1113, while inverters 1104 and 1106 are configured to receive phase signal 1114. In various embodiments, respective phases of phase signals 1113 and 1114 are different, and phase signals 1113 and 1114 may correspond to ones of phase signals 704, or any of signals 1010-1018 as depicted in FIG. 10.

Pass gate circuit 1109 is configured to receive a signal from inverter 1101 and transmit the signal from inverter 1101 to an input of inverter 1102, which is configured to generate phasor 1114. In a similar fashion, pass gate circuit 1112 is configured to receive a signal from inverter 1106 and transmit the signal from inverter 1106 to inverter 1107, which is configured to generate phasor 1117. In various embodiments, phasor 1115 and phasor 1117 may correspond to any of phasors 606 or signals 1010-1018 as depicted in FIG. 10.

Pass gate circuit 1110 is configured to receive a signal from inverter 1103 and transmit the signal from inverter 1103 to an input of inverter 1105. In a similar fashion, pass gate circuit 1111 is configured to receive a signal from inverter 1104 and transmit the signal from inverter 1104 to the input of inverter 1105. During operation, inverter 1103 may be sourcing current to the input of inverter 1105, while inverter 1104 may be sinking current from the input of inverter 1105. The summation of currents on the input of inverter 1105 results in phasor 1116 having a phase in between phasor 1115 and phasor 1117. In various embodiments, pass gate circuits 1110 and 1111 may help to wave shape the signal on the input of inverter 1105.

In some embodiments, inverters 1101 and 1103 may be larger in size than inverters 1104 and 1106. In such cases, optional inverter 1108 may be employed to match the load seen by phase signal 1114 to that seen by phase signal 1113.

In various embodiments, inverters 1101-1108 may be implemented as CMOS inverters circuits, or any suitable inverting amplifier circuits including those implemented in technologies other than CMOS. Pass gate circuits 1109-1112 may be implemented using at least one n-channel and p-channel MOSFET, FinFET, GAAFET, or other suitable transconductance devices.

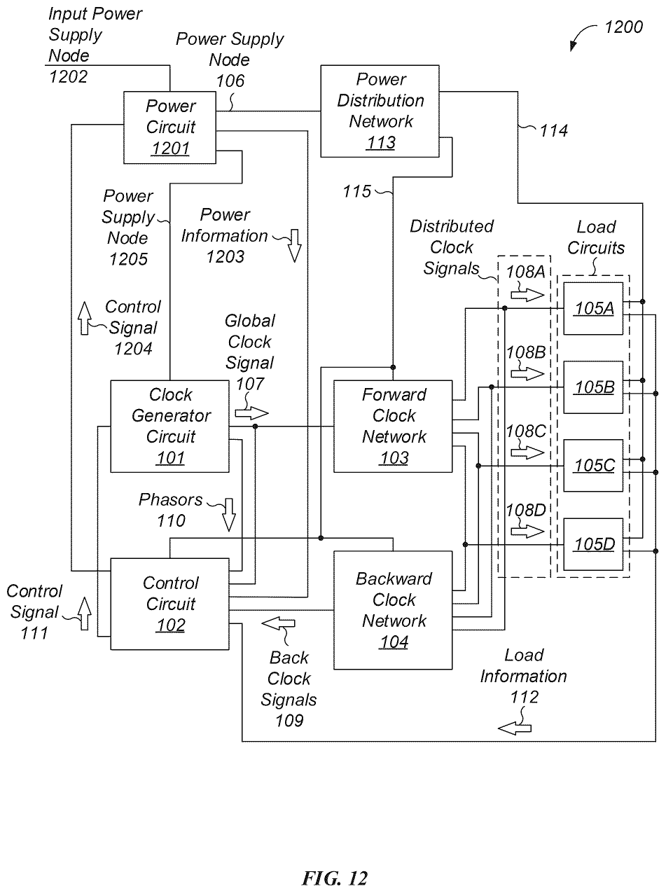

Turning to FIG. 12, a block diagram of a different embodiment of a computer system is depicted. As illustrated, computer system 1200 includes clock generator circuit 101, control circuit 102, forward clock network 103, backward clock network 104, load circuits 105A-105D, and power distribution network 113, each of which is configured to operate as described above. Additionally, computer system 1200 includes power circuit 1201 which is configured to generate, using a voltage level on input power supply node 1202, respective voltage levels on power supply node 106 and power supply node 1205. In some cases, the respective voltage levels on power supply node 106 and power supply node 1205 may be different. It is noted that power supply node 1205 may be a low-noise (also referred to as a “quiet”) power supply node, where noise on power supply node 1205 is less than noise on power supply node 106.

In various embodiments, power circuit 1201 is also configured to adjust the voltage level of power supply node 106 using control signal 1204. Power circuit 1201 may, in some embodiments, adjust a reference voltage based on control signal 1204 and generate the voltage level on power supply node 106 based on the adjusted value of the reference voltage. Alternatively, or additionally, power circuit 1201 may adjust one or more operational parameters using control signal 1204. For example, power circuit 1201 may adjust a duration of an on-time, a duration of an off-time, a frequency of a timing signal, or any other suitable operational parameter used to generate the voltage level on power supply node 106.

In some embodiments, power circuit 1201 is also configured to generate power information 1203. In various embodiments, power information 1203 may include information indicative of operational parameters such as those described above. Additionally, or alternatively, power information 1203 may include information indicative of a power state of computer system 1200.

Power circuit 1201 or portions of it may be implemented using a buck converter circuit or any other suitable type of power converter circuit. In other embodiments, power circuit 1201 may be implemented using an adjustable voltage regulator circuit such as a low-dropout (LDO) regulator circuit with adjustable reference, a switched-capacitor DC-to-DC converter circuit, or any other suitable type of regulator or power converter circuit.

In various embodiments, control circuit 102 is further configured to generate control signal 1204, using any suitable combination of power information 1203, phasors 110, back clock signals 109, and load information 112. For example, control circuit 102 may be further configured to generate control signal 1204 such that power circuit 1201 increases the voltage level on power supply node 106 in response to a determination that a voltage droop on node 114 has started and that load information 112 indicates a heavy computation load for load circuits 105A-105D. In various embodiments this information represents high-speed voltage transients on the power supply and can be supplemented by combination with absolute voltage measurements to determine if a high-speed droop has occurred during a low-voltage period.

To summarize, various embodiments of a computer system that includes a power supply voltage droop detection and compensation sub-system are disclosed. Broadly speaking, a clock generator circuit may be configured to generate a global clock signal. A forward clock network may be configured to distribute the global clock signal to generate a plurality of distributed clock signals. A backward clock network may be configured to select at least one of the plurality of distributed clock signals to generate at least one back clock signal. A control circuit may be configured to perform a phase comparison between the global clock signal and the at least one back clock signal. The clock generator circuit may be further configured to modify the global clock signal using a result of the phase comparison.

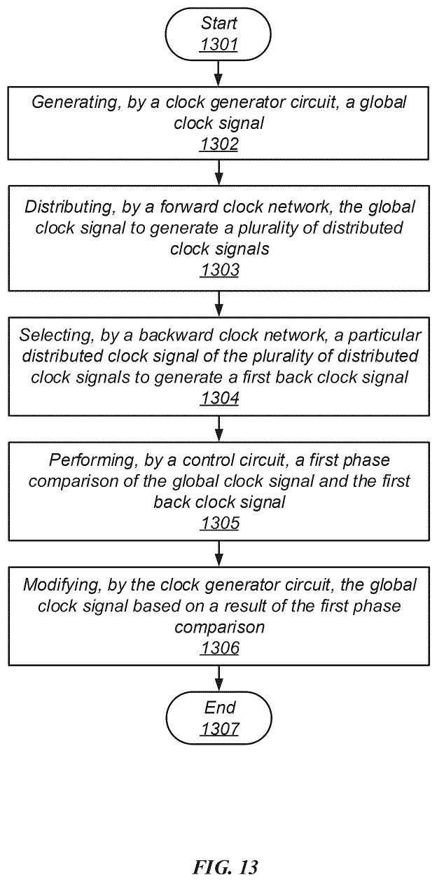

Turning to FIG. 13, a method for detecting power supply droop in a computer system is illustrated. The method, which may be applied to various computer systems, e.g., computer systems 100 and 1200 as depicted in FIGS. 1 and 12, respectively, begins in block 1301.

The method includes generating, by a clock generator circuit, a global clock signal (block 1302). In various embodiments, generating the global clock signal may include generating, by the clock generator circuit, a plurality of phasors with respective phase relationships to the global clock signals. In some embodiments, the method may include generating, by an injection-locked oscillator circuit using the global clock signal, a plurality of phase signals. In such cases, the method may further include generating, by a phase blender circuit using at least two of the plurality of phase signals, the plurality of phasors.

The method also includes distributing, by a forward clock network, the global clock signal to generate a plurality of distributed clock signals (block 1303). In various embodiments, distributing the global clock signal includes generating, by a plurality of buffer circuit, a plurality of buffered versions of the global clock signal.

The method further includes selecting, by a backward clock network, a particular distributed clock signal of the plurality of distributed block signals to generate a first back clock signal (block 1304). In other embodiments, the method may further include selecting, by the back clock network, a different distributed clock signal of the plurality of distributed clock signals to generate a second back clock signal.

In some embodiments, the particular distributed clock signal may be coupled to a first load circuit, and the different distributed clock signal may be coupled to a second load circuit. In various embodiments, the first load circuit and the second load circuit may be located a threshold distance apart on a common integrated circuit. In some cases, a first impedance between a first power terminal of the first load circuit to an output terminal of a power circuit may be different than a second impedance between a second power terminal of the second load circuit to the output terminal of the power circuit.

In some embodiments, the method may further include selecting, by the backward clock network in response to determining a computer system is operating under a first compute load, the particular distributed clock signal. In such cases, the computer system may include the clock generator circuit, the forward clock network, the backward clock network, and the control circuit. The method may further include selecting, by the backward clock network, in response to determining the computer system is operating under a second computer load, a different distributed clock signal of the plurality of distributed clock signals to generate the first back clock signal.

The method also includes performing, by a control circuit, a first phase comparison of the global clock signal and the first back clock signal (block 1305). In other embodiments, the method may further include performing, by the control circuit, a second phase comparison of the global clock signal and the second back clock signal.

In various embodiments, performing the first phase comparison may include comparing a first rising edge of the global clock signal to a corresponding rising edge of the first back clock signal. Additionally, the method may include comparing a first falling edge of the global clock signal to a corresponding falling edge of the first back clock signal. In some embodiments, performing the first phase comparison my include comparing the first back clock signal to at least one of the plurality of phasors.

In some cases, the method may further include determining, by the control circuit, a frequency and a magnitude of a change in voltage level of a power supply node using the first result. In such cases, the method may additionally include modifying, by the clock generator circuit based on the frequency and magnitude, and adjusting, by a power circuit, the voltage level of the power supply node using the frequency and magnitude.

The method further includes modifying, by the clock generator circuit, the global clock signal based on a result of the first phase comparison (block 1306). In other embodiments, the method may further include modifying, by the clock generator circuit, the global clock signal using the first result and a second result of the second phase comparison.

In some embodiments, modifying the global clock signal includes decreasing, by the clock generator circuit, a frequency of the global clock signal. Alternatively, or additionally, modifying the global clock signal may include selecting a particular phasor of the plurality of phasors using the first result, and generating the global clock signal using the particular phasor. In other embodiments, modifying the global clock signal may include skipping at least one cycle of the global clock signal of a plurality of cycles included in a particular period of time. The method concludes in block 1307.

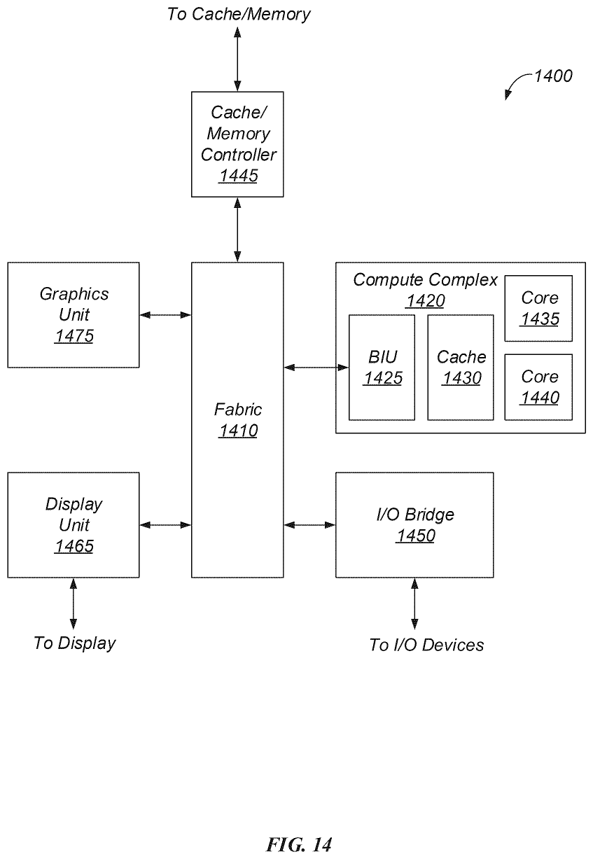

Referring now to FIG. 14, a block diagram illustrating an example embodiment of a device is shown. In some embodiments, elements of device 1400 may be included within a system on a chip. In some embodiments, device 1400 may be included in a mobile device, which may be battery-powered. Therefore, power consumption by device 1400 may be an important design consideration. In the illustrated embodiment, device 1400 includes fabric 1410, compute complex 1420, input/output (I/O) bridge 1450, cache/memory controller 1445, graphics unit 1475, and display unit 1465. In some embodiments, device 1400 may include other components (not shown) in addition to, or in place of, the illustrated components, such as video processor encoders and decoders, image processing or recognition elements, computer vision elements, etc.

Fabric 1410 may include various interconnects, buses, MUX's, controllers, etc., and may be configured to facilitate communication between various elements of device 1400. In some embodiments, portions of fabric 1410 may be configured to implement various different communication protocols. In other embodiments, fabric 1410 may implement a single communication protocol, and elements coupled to fabric 1410 may convert from the single communication protocol to other communication protocols internally.

In the illustrated embodiment, compute complex 1420 includes bus interface unit (BIU) 1425, cache 1430, and cores 1435 and 1440. In various embodiments, compute complex 1420 may include various numbers of processors, processor cores, and caches. For example, compute complex 1420 may include 1, 2, or 4 processor cores, or any other suitable number. In one embodiment, cache 1430 is a set associative L2 cache. In some embodiments, cores 1435 and 1440 may include internal instruction and data caches. In some embodiments, a coherency unit (not shown) in fabric 1410, cache 1430, or elsewhere in device 1400, may be configured to maintain coherency between various caches of device 1400. BIU 1425 may be configured to manage communication between compute complex 1420 and other elements of device 1400. Processor cores, such as cores 1435 and 1440, may be configured to execute instructions of a particular instruction set architecture (ISA) which may include operating system instructions and user application instructions. These instructions may be stored in a computer readable medium such as a memory coupled to cache/memory controller 1445 as discussed below.

As used herein, the term “coupled to” may indicate one or more connections between elements, and a coupling may include intervening elements. For example, in FIG. 14, graphics unit 1475 may be described as “coupled to” a memory through fabric 1410 and cache/memory controller 1445. In contrast, in the illustrated embodiment of FIG. 14, graphics unit 1475 is “directly coupled”to fabric 1410 because there are no intervening elements.

Cache/memory controller 1445 may be configured to manage transfer of data between fabric 1410 and one or more caches and memories. For example, cache/memory controller 1445 may be coupled to an L3 cache, which may, in turn, be coupled to a system memory. In other embodiments, cache/memory controller 1445 may be directly coupled to a memory. In some embodiments, cache/memory controller 1445 may include one or more internal caches. Memory coupled to cache/memory controller 1445 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 1445 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1420 to cause the computing device to perform functionality described herein.

Graphics unit 1475 may include one or more processors, e.g., one or more graphics processing units (GPUs). Graphics unit 1475 may receive graphics-oriented instructions, such as OPENGL®, Metal®, or DIRECT3D® instructions, for example. Graphics unit 1475 may execute specialized GPU instructions or perform other operations based on the received graphics-oriented instructions. Graphics unit 1475 may generally be configured to process large blocks of data in parallel, and may build images in a frame buffer for output to a display, which may be included in the device or may be a separate device. Graphics unit 1475 may include transform, lighting, triangle, and rendering engines in one or more graphics processing pipelines. Graphics unit 1475 may output pixel information for display images. Graphics unit 1475, in various embodiments, may include programmable shader circuitry which may include highly parallel execution cores configured to execute graphics programs, which may include pixel tasks, vertex tasks, and compute tasks (which may or may not be graphics-related).

Display unit 1465 may be configured to read data from a frame buffer and provide a stream of pixel values for display. Display unit 1465 may be configured as a display pipeline in some embodiments. Additionally, display unit 1465 may be configured to blend multiple frames to produce an output frame. Further, display unit 1465 may include one or more interfaces (e.g., MIPI® or embedded display port (eDP)) for coupling to a user display (e.g., a touchscreen or an external display).

I/O bridge 1450 may include various elements configured to implement universal serial bus (USB) communications, security, audio, and low-power always-on functionality, for example. I/O bridge 1450 may also include interfaces such as pulse-width modulation (PWM), general-purpose input/output (GPIO), serial peripheral interface (SPI), and inter-integrated circuit (I2C), for example. Various types of peripherals and devices may be coupled to device 1400 via I/O bridge 1450.

In some embodiments, device 1400 includes network interface circuitry (not explicitly shown), which may be connected to fabric 1410 or I/O bridge 1450. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1400 with connectivity to various types of other devices and networks.

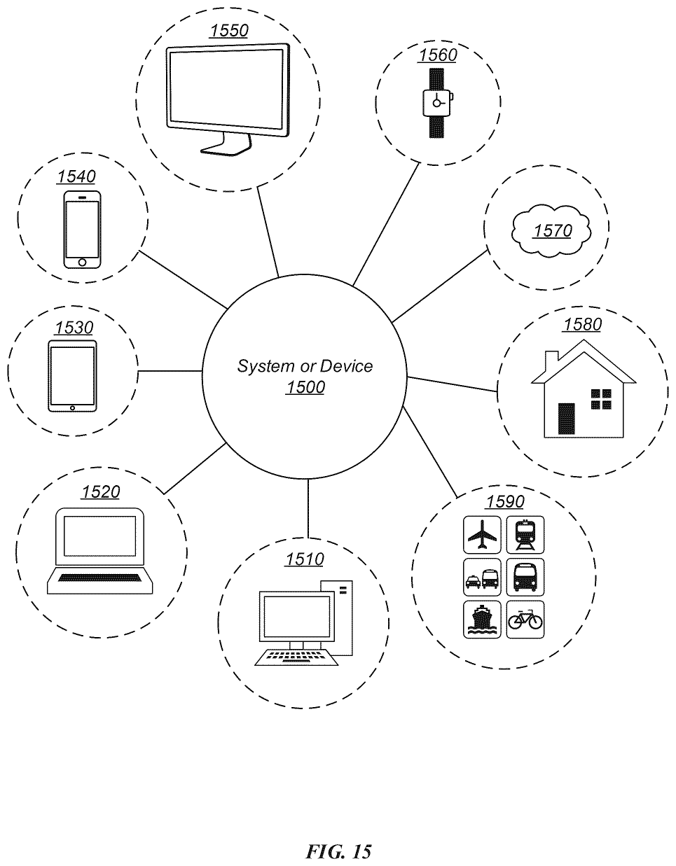

Turning now to FIG. 15, various types of systems that may include any of the circuits, devices, or systems discussed above are illustrated. System or device 1500, which may incorporate or otherwise utilize one or more of the techniques described herein, may be utilized in a wide range of areas. For example, system or device 1500 may be utilized as part of the hardware of systems such as a desktop computer 1510, laptop computer 1520, tablet computer 1530, cellular or mobile phone 1540, or television 1550 (or set-top box coupled to a television).

Similarly, disclosed elements may be utilized in a wearable device 1560, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1500 may also be used in various other contexts. For example, system or device 1500 may be utilized in the context of a server computer system, such as a dedicated server or on shared hardware that implements a cloud-based service 1570. Still further, system or device 1500 may be implemented in a wide range of specialized everyday devices, including devices 1580 commonly found in the home such as refrigerators, thermostats, security cameras, etc. The interconnection of such devices is often referred to as the “Internet of Things” (IoT). Elements may also be implemented in various modes of transportation. For example, system or device 1500 could be employed in the control systems, guidance systems, entertainment systems, etc. of various types of vehicles 1590.

The applications illustrated in FIG. 15 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

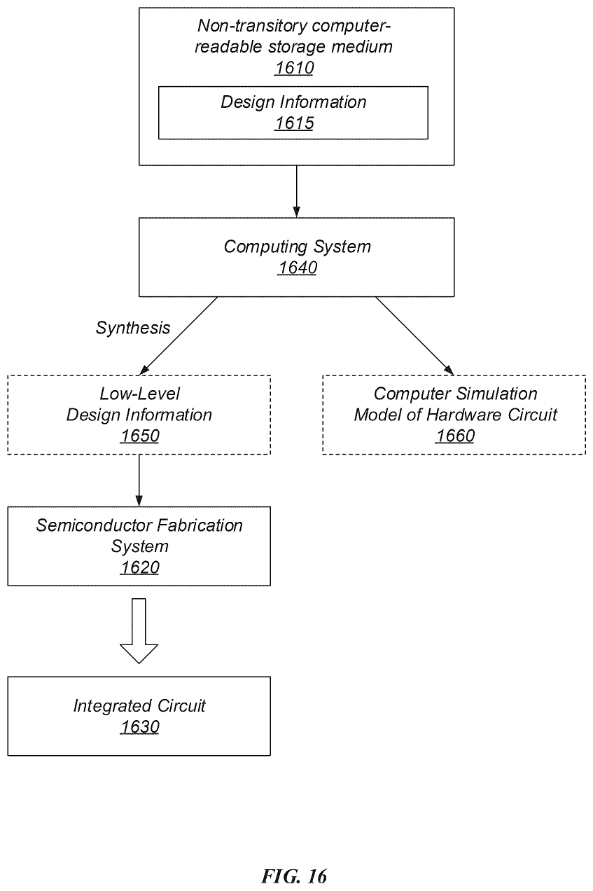

FIG. 16 is a block diagram illustrating an example of a non-transitory computer-readable storage medium that stores design information 1615, according to some embodiments. In the illustrated embodiment, computing system 1640 is configured to process design information 1615. This may include executing instructions included in design information 1615, interpreting instructions included in design information 1615, compiling, transforming, or otherwise updating design information 1615, etc. Therefore, design information 1615 controls computing system 1640 (e.g., by programming computing system 1640) to perform various operations discussed below, in some embodiments.

In the illustrated example, computing system 1640 processes design information 1615 to generate both computer simulation model of hardware circuit 1660 and low-level design information 1650. In other embodiments, computing system 1640 may generate only one of these outputs, may generate other outputs based on design information 1615, or both. Regarding computer simulation model of hardware circuit 1660, computing system 1640 may execute instructions of a hardware description language that includes register transfer level (RTL) code, behavioral code, structural code, or some combination thereof. The simulation model may perform the functionality specified by design information 1615, facilitate verification of the functional correctness of the hardware design, generate power consumption estimates, generate timing estimates, etc.

In the illustrated example, computing system 1640 also processes design information 1615 to generate low-level design information 1650 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1650 (potentially among other inputs), semiconductor fabrication system 1620 is configured to fabricate integrated circuit 1630 (which may correspond to functionality of the computer simulation model of hardware circuit 1660). Note that computing system 1640 may generate different simulation models based on design information at various levels of description, including low-level design information 1650, design information 1615, and so on. The data representing low-level design information 1650 and computer simulation model of hardware circuit 1660 may be stored on non-transitory computer-readable storage medium 1610, or on one or more other media.

In some embodiments, low-level design information 1650 controls (e.g., programs) semiconductor fabrication system 1620 to fabricate integrated circuit 1630. Thus, when processed by the fabrication system, the design information may program the fabrication system to fabricate a circuit that includes various circuitry disclosed herein.

Non-transitory computer-readable storage medium 1610 may comprise any of various appropriate types of memory devices or storage devices. Non-transitory computer-readable storage medium 1610 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Non-transitory computer-readable storage medium 1610 may include other types of non-transitory memory as well, or combinations thereof. Accordingly, non-transitory computer-readable storage medium 1610 may include two or more memory media, which may reside in different locations—for example, in different computer systems that are connected over a network.

Design information 1615 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1640, semiconductor fabrication system 1620, or both. In some embodiments, design information 1615 may also include one or more cell libraries that specify the synthesis, layout, or both of integrated circuit 1630. In some embodiments, design information 1615 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1630 may, in various embodiments, include one or more custom macrocells, such as memories, analog or mixed-signal circuits, and the like. In such cases, design information 1615 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1620 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1620 may also be configured to perform various testing of fabricated circuits for correct operation.

In various embodiments, integrated circuit 1630 and computer simulation model of hardware circuit 1660 are configured to operate according to a circuit design specified by design information 1615, which may include performing any of the functionality described herein. For example, integrated circuit 1630 may include any of various elements shown in FIG. 1-11. Further, integrated circuit 1630 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1615. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1615 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1650. Low-level design information 1650 may program semiconductor fabrication system 1620 to fabricate integrated circuit 1630.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more. ” Reference to “an item” in a claim thus does not, without accompanying context, preclude additional instances of the item. A “plurality”of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B. ” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to. ” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for”[performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a clock generator circuit configured to generate a global clock signal;
a forward clock network configured to distribute the global clock signal to a plurality of distributed clock signals;
a backward clock network configured to select at least one of the plurality of distributed clock signals to generate at least one back clock signal; and
a control circuit configured to perform a phase comparison between the global clock signal and the at least one back clock signal; and
wherein the clock generator circuit is further configured to modify the global clock signal using a result of the phase comparison.

2. The apparatus of claim 1, wherein to modify the global clock signal, the clock generator circuit is further configured to decrease a frequency of the global clock signal using the result of the phase comparison.

3. The apparatus of claim 1, wherein to modify the global clock signal, the clock generator circuit is further configured to phase shift the global clock signal using the result of the phase comparison.

4. The apparatus of claim 1, wherein the backward clock network includes a plurality of multiplex circuits and a plurality of first buffer circuits, wherein a particular multiplex circuit of the plurality of multiplex circuits is configured to select, using a selection signal, between a first distributed clock signal of the plurality of distributed clock signals and a second distributed clock signal of the plurality of distributed clock signals to generate an intermediate clock signal, and wherein a particular buffer circuit of the plurality of first buffer circuits is configured to buffer the intermediate clock signal to generate a buffered clock signal.

5. The apparatus of claim 4, wherein the forward clock network includes a plurality of second buffer circuits, and wherein at least one first transistor included in a given first buffer circuit of the plurality of first buffer circuits has a first threshold voltage, and at least one second transistor included in a given second buffer circuit of the plurality of second buffer circuits has a second threshold voltage less than the first threshold voltage.

6. The apparatus of claim 1, wherein to generate the global clock signal, the clock generator circuit is further configured to generate a plurality of phasors, and wherein to perform the phase comparison, the control circuit is further configured to perform respective phase comparisons of the at least one back clock signal and the plurality of phasors.

7. A method, comprising:
generating, by a clock generator circuit, a global clock signal;
distributing, by a forward clock network, the global clock signal to generate a plurality of distributed clock signals;
selecting, by a backward clock network, a particular distributed clock signal of the plurality of distributed clock signals to generate a first back clock signal;
performing, by a control circuit, a first phase comparison of the global clock signal and the first back clock signal; and
modifying, by the clock generator circuit, the global clock signal using a first result of the first phase comparison.

8. The method of claim 7, further comprising:
selecting, by the backward clock network, a different distributed clock signal of the plurality of distributed clock signals to generate a second back clock signal;
performing, by the control circuit, a second phase comparison of the global clock signal and the second back clock signal; and
modifying, by the clock generator circuit, the global clock signal using the first result and a second result of the second phase comparison.

9. The method of claim 7, further comprising:
selecting, by the backward clock network, in response to determining a computer system is operating under a first compute load, the particular distributed clock signal, wherein the computer system includes the clock generator circuit, the forward clock network, the backward clock network, and the control circuit; and
selecting, by the backward clock network, in response to determining the computer system is operating under a second compute load, a different distributed clock signal of the plurality of distributed clock signals to generate the first back clock signal.

10. The method of claim 7, wherein performing the first phase comparison includes:
comparing a first rising edge of the global clock signal to a corresponding rising edge of the first back clock signal; and
comparing a first falling edge of the global clock signal to a corresponding falling edge of the first back clock signal.

11. The method of claim 7, further comprising:
determining, by the control circuit, a frequency and a magnitude of a change in a voltage level of a power supply node using the first result; and
modifying, by the clock generator circuit, the global clock signal based on the frequency and the magnitude.

12. The method of claim 7, wherein modifying the global clock signal includes decreasing, by the clock generator circuit, a frequency of the global clock signal.

13. The method of claim 7, wherein generating the global clock signal includes generating a plurality of phasors, wherein the plurality of phasors have different phases relative to the global clock signal, and wherein modifying the global clock signal includes:
selecting a particular phasor of the plurality of phasors using the first result; and
generating the global clock signal using the particular phasor.

14. A system, comprising:
a power circuit configured to generate a regulated voltage using an input voltage;
a clock generator circuit configured to generate a global clock signal using the regulated voltage;
a forward clock network configured to distribute the global clock signal to generate a plurality of distributed clock signals;
one or more logic circuits including a particular logic circuit configured to perform a particular operation using a particular distributed clock signal of the plurality of distributed clock signals and the regulated voltage;
a backward clock network configured to select the particular distributed clock signal to generate a first back clock signal; and
a control circuit configured to perform a phase comparison between the global clock signal and the first back clock signal; and
wherein the clock generator circuit is further configured to modify the global clock signal using a result of the phase comparison.

15. The system of claim 14, wherein the one or more logic circuits includes a different logic circuit configured to perform a different operation using a different distributed clock signal of the plurality of distributed clock signals and the regulated voltage, wherein the backward clock network is further configured to select the different distributed clock signal to generate a second back clock signal, and wherein the control circuit is further configured to perform the phase comparison using the global clock signal, the first back clock signal, and the second back clock signal.

16. The system of claim 15, wherein the power circuit, the clock generator circuit, the forward clock network, the backward clock network, the control circuit, and the one or more logic circuits are included on a common integrated circuit, wherein the particular logic circuit and the different logic circuit are located at least a threshold distance from each other, and wherein a first impedance between a first power terminal of the particular logic circuit and an output terminal of the power circuit is different than a second impedance between a second power terminal of the different logic circuit and the output terminal of the power circuit.

17. The system of claim 14, wherein to modify the global clock signal, the clock generator circuit is further configured to skip at least one cycle in a plurality of cycles included in the global clock signal within a particular period of time.

18. The system of claim 14, wherein the control circuit is further configured to generate supply transient information using the result of the phase comparison, and wherein the power circuit is further configured to adjust the regulated voltage using the transient information.

19. The system of claim 14, wherein to modify the global clock signal, the clock generator circuit is further configured, using the result of the phase comparison, to change a frequency of the global clock signal from a first frequency to a second frequency less than the first frequency.

20. The system of claim 19, wherein the control circuit is further configured to determine a duration of a transient in the regulated voltage using the result of the phase comparison, and wherein the clock generator circuit is further configured to change the frequency of the global clock signal from the second frequency to the first frequency.
